(19) United States
(12) Patent Application Publication
(10) Pub. No.: US 2012/0261047 A1
(43) Pub. Date: Oct. 18, 2012

(54) METHOD TO REDUCE PLACEMENT VOIDS

(76) Inventors: Raj Peddi, Irvine, CA (US); Hoseung Yoo, Cypress, CA (US); Stephen Aldo Ruatta, South Pasadena, CA (US)

(21) Appl. No.: 13/445,039

(22) Filed: Apr. 12, 2012

Related U.S. Application Data
(60) Provisional application No. 61/475,730, filed on Apr. 15, 2011.

(51) Int. Cl. B32B 37/12

(52) U.S. Cl. 156/60

(57) ABSTRACT

A method of applying an adhesive material between two flat substrates to eliminate or reduce placement voids comprises applying an adhesive material on one substrate in a dome shape, contacting the second substrate with the adhesive material in the dome shape, and applying an effective amount of force to bring the two substrates together and push out any entrapped air, thereby disposing the adhesive material between the substrates and eliminating the formation of voids.

### CROSS-REFERENCE TO RELATED APPLICATION

This application claims the benefit of U.S. patent application Ser. No. 61/475,730 filed Apr. 15, 2011, the contents of which are incorporated herein by reference.

### BACKGROUND OF THE INVENTION

This invention is a method to reduce air voids in adhesive, coating, or sealing materials that are disposed between two substrates. It is particularly suited for use in the fabrication of semiconductors and electronic devices.

In many industries, adhesive, coating, and sealant materials are used between two or more substrates. When both substrates are flat surfaces, the placement of one flat surface onto another traps air or gaseous bubbles within the material creating voids. If these voids are not eliminated, they can cause failure of the adhesive, coating, or sealant.

The presence of voids in adhesives, coatings and sealants used in the semiconductor packaging industry can lead to a failure in performance and loss of reliability in the ultimate device. There are numerous applications in which an adhesive, coating, or sealant is disposed between two flat substrates, such as, in the attachment of semiconductor dies to circuit boards or to other dies, in the application of encapsulant adhesives to protect solder connections, in the sealing of color filter glass for hand-held devices, such as, electronic books and readers. Due to the relatively high cost of electronic devices, there is an incentive to correct the problem of these placement voids so that manufacturing through-put can be increased and cost reduced.

### SUMMARY OF THE INVENTION

This invention is a method of applying an adhesive material between two flat substrates so as to eliminate or reduce placement voids. The method comprises applying an adhesive material on one substrate in a dome shape, contacting the second substrate with the adhesive material in the dome shape, and applying an effective amount of force to bring the two substrates together and push out any entrapped air. Heat can be applied in an effective amount if needed.

### BRIEF DESCRIPTION OF THE DRAWINGS

FIG. 1 is a depiction of the formation of voids when two flat surfaces are contacted with a uniformly coated material between them.

FIG. 2 is a depiction of a dome shaped material on one substrate and the contacting of that material with a second substrate to show the elimination of voids.

FIG. 3 is depiction of a dome shaped glob of material on one substrate and the contacting of that material with a second substrate previously uniformly coated with the same or different material, showing the elimination of voids as the entrapped air is pushed out.

FIG. 4 is a depiction of a printing screen designed to achieve dome shaped coating.

FIG. 5 is a depiction of a screen with reservoirs designed to achieve dome shaped coating.

FIG. 6 is a depiction of a jet-spraying means for delivering material onto a substrate in a dome shaped coating.

FIG. 7 is a depiction of an ink-jetting means for delivering material onto a substrate in a dome shaped coating.

FIG. 8 is a depiction of a spin-coating means for delivering material onto a substrate in a dome shaped coating.

### DETAILED DESCRIPTION OF THE INVENTION

For the purposes of this specification and the claims, the term “adhesive materials” will be deemed to cover those chemical materials that have adhesive properties, such as adhesives, coatings, and sealants; and the term “voids” or “placement voids” will be deemed to mean air bubbles or other gaseous bubbles (collectively “air” or “air bubbles”) entrapped within adhesive materials.

The substrates can be any flat surfaces that need to be adhered. The adhesive material can be any adhesive material desired for its performance properties and that has a viscosity sufficiently high not to flow off the substrates in the time needed for the two substrates to be adhered. The appropriate viscosity and performance characteristics are determined by the practitioner.

This method to reduce voids centers on the fact that the adhesive material is presented in a dome shape. The top of the dome is formed in the center of the area on the first substrate, which first substrate will be adhered to the second substrate. The top of the adhesive material dome makes first contact with the second substrate, and then as the two substrates are brought closer together, the adhesive material flattens out between the substrates, pushing out any entrapped air to eliminate or reduce the formation of voids.

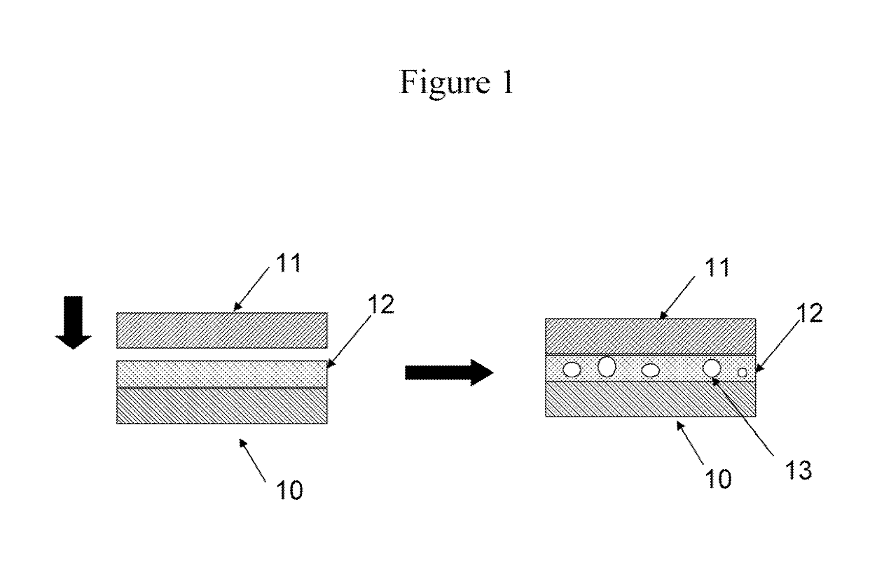

FIG. 1 is a depiction of a prior art typical placement of an adhesive material 12 on one substrate 10 contacted with a second substrate 11, and shows the formation of voids 13.

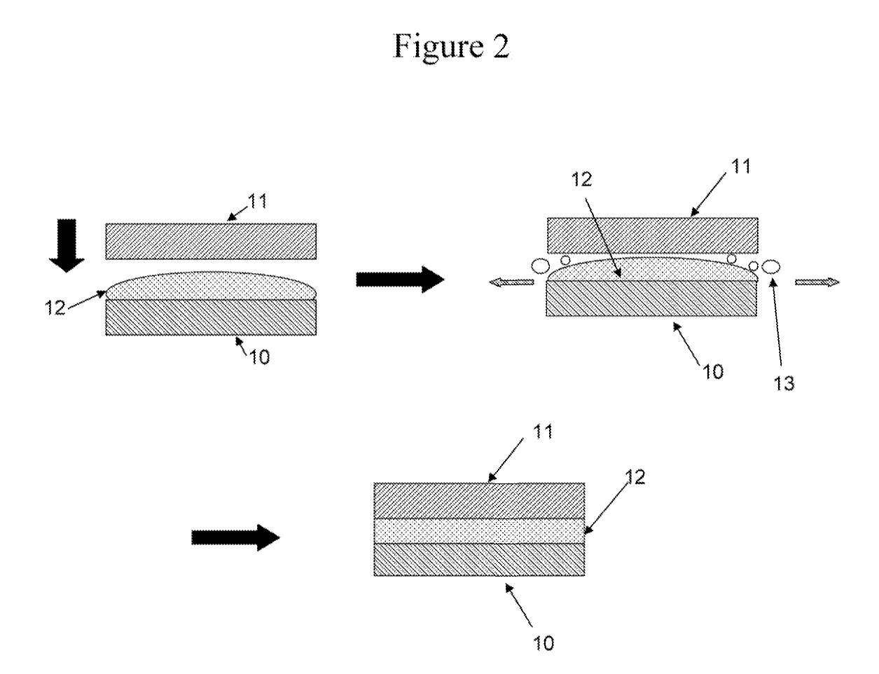

FIG. 2 is a depiction of the result achieved with the inventive method. A dome shaped adhesive material 12 on one substrate 10 is contacted with a second substrate 11. As the dome shaped adhesive material 12 reaches the second substrate 11, the top of the dome of the adhesive material makes contact with the second substrate before the remainder of the adhesive material makes contact. Then as the two substrates 10 and 11 are moved closer together, the entrapped air 13 is squeezed out. Due to the dome shape of the adhesive material, the entrapped air has an escape route and is not trapped within the adhesive material.

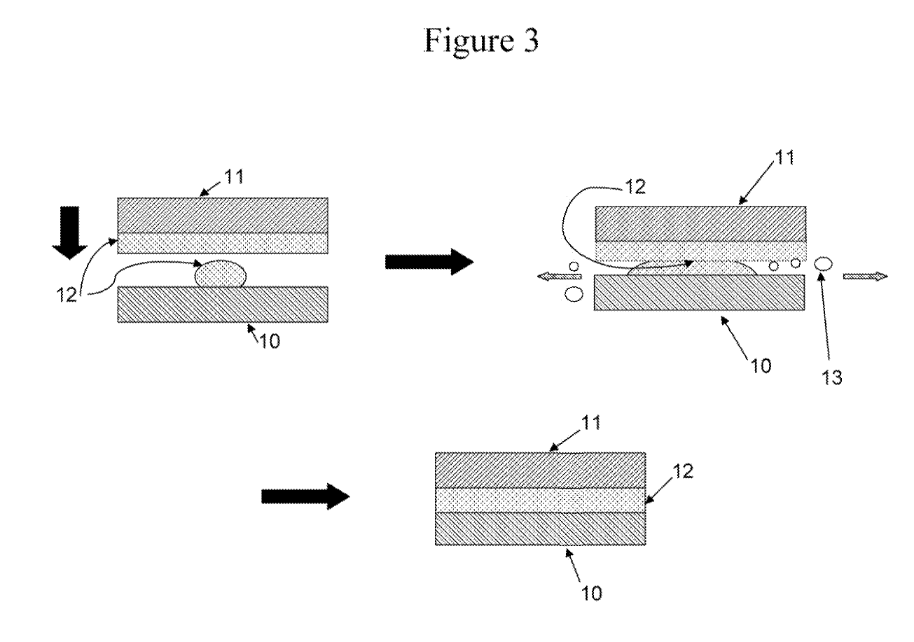

FIG. 3 is a depiction of a similar method to that depicted in FIG. 2. In this embodiment, a dome shaped glob of adhesive material 12 is placed on one substrate 10, and the second substrate 11 is uniformly coated with the same or different adhesive material 12. The contact of substrate 11, uniformly coated with adhesive material 12, with the dome shaped glob of adhesive material 12 on the first substrate 10, creates an escape path for the entrapped air 13 so it is not trapped within the adhesive material.

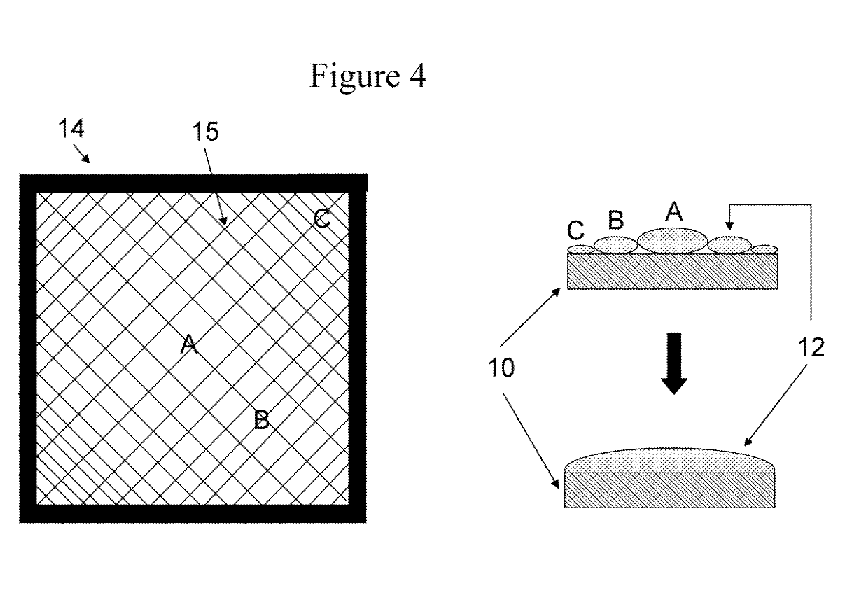

The adhesive material can be shaped into a dome by any effective means. Examples of suitable methods for creating a dome shape of adhesive material are shown in FIGS. 4, 5, 6, 7, and 8.

In one embodiment, the dome shape is created by passing the adhesive material through a screen positioned above the substrate. The wires of the screen can be fabricated from any material capable of being formed into wires, and are not limited to metal wires. FIG. 4 shows the use of a screen 14 for printing the adhesive material 12 onto a substrate 10 in a dome shape. The wires 15 of the screen are spaced furthest apart in the middle of the screen area and become progressively closer together toward the periphery of the screen. This allows adhesive material 12 to be deposited most heavily in the center of the screen and gradually and progressively less heavily toward the periphery, thereby forming a dome shape.

In FIG. 4, the screen area designated A has the widest spacings; the screen area designated B has smaller spacings; and the screen area designated C has the smallest spacings. The amount of deposited adhesive material 12 designated A, B, and C, on substrate 10 is related to the corresponding openings in the screen. Thus, in the embodiment shown in FIG. 4, the invention is a method of forming an adhesive material on a substrate into a dome shape comprising passing the adhesive material through a screen of wires, positioned over the substrate, in which the wires are spaced farther apart in the center area of the screen than at the perimeter of the screen and become spaced gradually and progressively closer together from the center toward the perimeter of the screen, whereby a dome shape of adhesive material is deposited on the substrate.

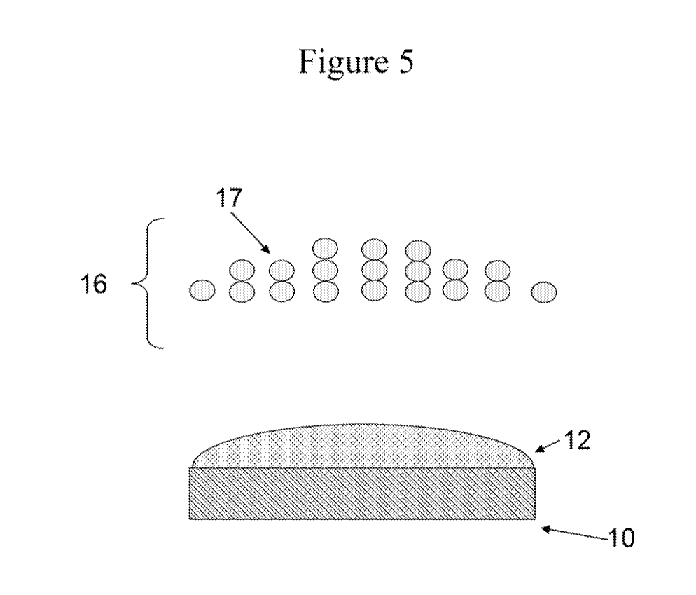

In another embodiment, the dome shape is created by passing the adhesive material through a screen with reservoirs of varying capacity. FIG. 5 depicts the use of a screen 16 in which the reservoirs for storing the adhesive material to be deposited are deeper in the center area of the screen. The reservoirs can be created from varying numbers of layers of mesh 17 or from wires of varying thickness (not illustrated). The wire or mesh can be fabricated from any suitable material. More layers of stacked mesh or thicker wires are used in the center of the screen, forming deeper reservoirs, and allowing more adhesive material to be stored in this area of the screen for later deposit. If stacked layers of mesh are used to form the reservoirs, the number of layers of mesh is graduated so that progressively fewer layers are used the further away they are from the center of the screen. If wires are used to form the reservoirs, the thickness of the wire is graduated so that progressively thinner wires are used the further away they are from the center of the screen. The fewer the layers of mesh or the thinner the wires, the less material is deposited, creating a dome shaped deposit of adhesive material 12.

Thus, in the embodiment shown in FIG. 5, the invention is a method of forming an adhesive material on a substrate into a dome shape comprising passing the adhesive material through a screen, positioned over the substrate, the screen having varying sizes of reservoirs containing material to be deposited, in which the reservoirs are deeper in the center area of the screen than at the perimeter of the screen and become gradually and progressively shallower from the center toward the perimeter of the screen, whereby a dome shape of adhesive material is deposited on the substrate.

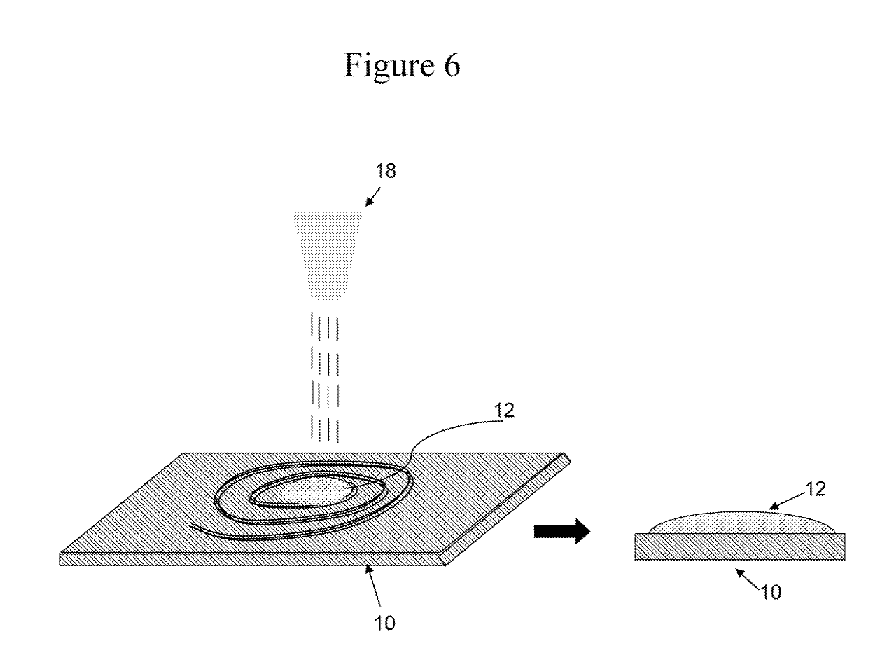

FIG. 6 depicts the use of a jet-spray for depositing adhesive material 12 in a dome shape. In one embodiment as shown in FIG. 6, the jet-spray head 18 traces a spiral progression across the surface of the substrate 10 being coated, proceeding from the center to the perimeter. The highest level of material is deposited in the center of the substrate, with gradually and progressively less being deposited toward the perimeter, so that a dome shaped deposit of adhesive material 12 is created.

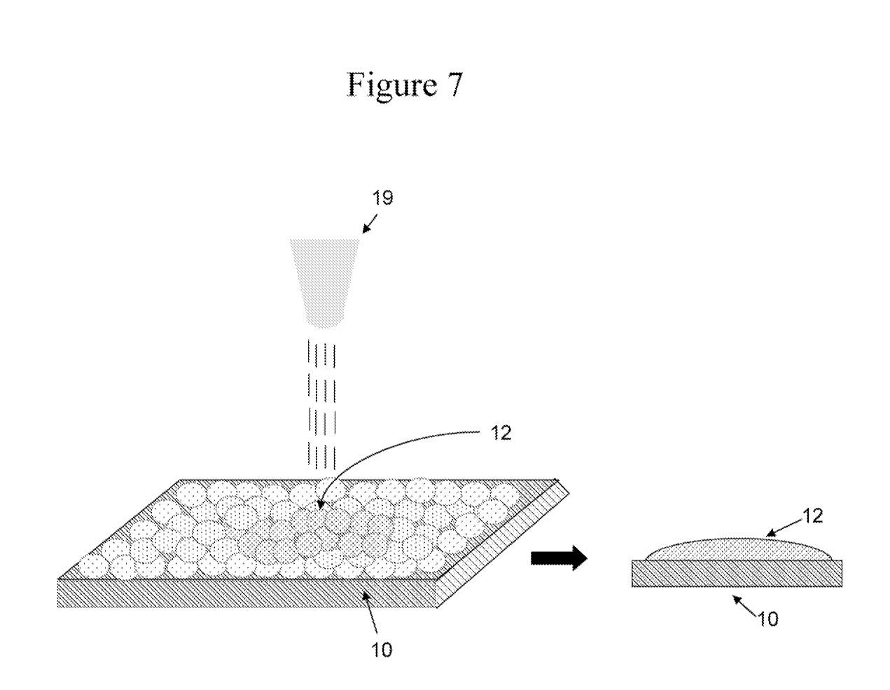

FIG. 7 depicts the use of an ink-jet for depositing adhesive material 12 in a dome shape. The ink jet head 19 is programmed to deposit the highest level of material in the center of the substrate 10, and gradually and progressively deposit less toward the perimeter of the substrate, so that a dome shaped deposit of adhesive material 12 is created.

Thus, in the embodiments shown in FIGS. 6 and 7, this invention is a method of forming an adhesive material onto a substrate into a dome shape comprising jet-spraying or ink-jetting the adhesive material on a substrate so that the highest level of material is deposited in the center of the substrate, with gradually and progressively less being deposited toward the perimeter of the substrate, whereby a dome shape of adhesive material is deposited on the substrate.

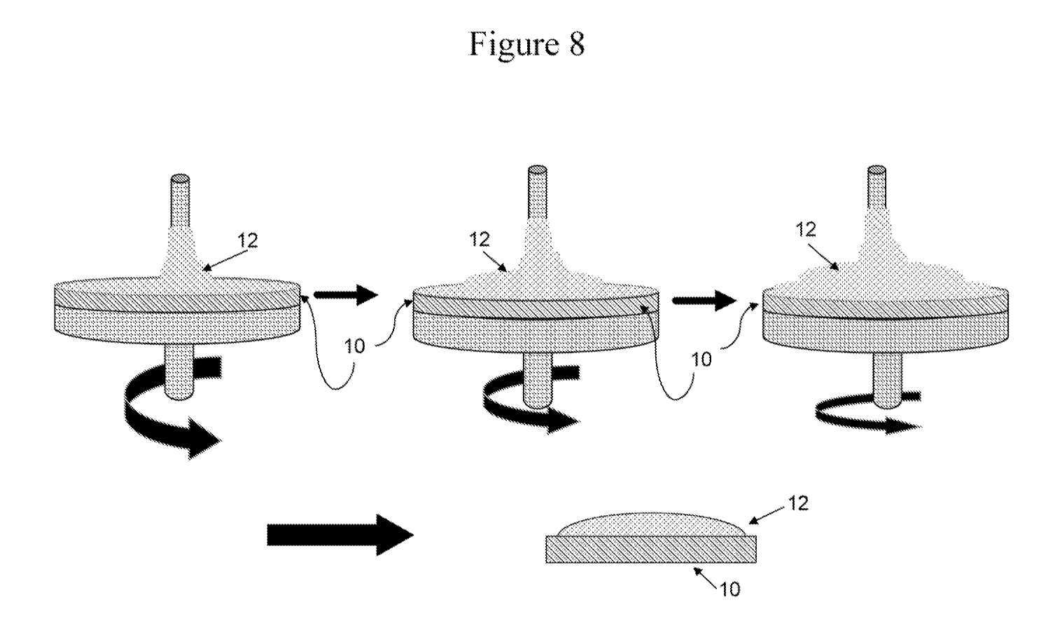

In a further embodiment shown in FIG. 8, the adhesive material 12 is deposited in a dome shape by spin coating. The adhesive material 12 is first deposited in the center of the substrate 10 and then spun out using centripetal force. The spinning can be programmed so that it decelerates over time, thereby depositing gradually and progressively less material at the periphery of the substrate 10. Alternatively, the dome can be created with several deposits of adhesive material onto the spinning substrate, whereby the first deposit is spun out to the perimeter of the substrate and each subsequent deposit is spun out gradually and progressively less, thereby leaving more material in the center of the substrate and creating a dome shape of adhesive material 12.

Thus, in the embodiment shown in FIG. 8, the invention is a method of forming an adhesive material on a substrate into a dome shape comprising depositing the adhesive material on the substrate by spin coating in which the adhesive material is spun out over the substrate using centripetal force and the spinning decelerates over time, whereby a dome shape of adhesive material is created.

What is claimed:

1. A method of applying an adhesive material between two flat substrates to eliminate or reduce placement voids comprising:
(a) applying an adhesive material on one substrate in a dome shape,
(b) contacting the second substrate with the adhesive material in the dome shape, and
(c) applying an effective amount of force to bring the two substrates together and push out any entrapped air.

2. The method according to claim 1 in which the adhesive material is applied to the substrate in a dome shape by passing the adhesive material through a screen of wires positioned above the substrate, in which the wires of the screen are spaced farther apart in the center area of the screen than at the perimeter of the screen and become spaced gradually and progressively closer together from the center toward the perimeter of the screen, whereby a dome shape of adhesive material is deposited on the substrate.

3. The method according to claim 1 in which the adhesive material is applied to the substrate in a dome shape by passing the adhesive material through a screen positioned above the substrate, the screen having varying sizes of reservoirs containing material to be deposited, in which the reservoirs are deeper in the center area of the screen than at the perimeter of the screen and become gradually and progressively shallower from the center toward the perimeter of the screen, whereby a dome shape of adhesive material is deposited on the substrate.

4. The method according to claim 1 in which the adhesive material is applied to the substrate in a dome shape by jet-spraying or ink jetting the adhesive material onto the substrate so that the highest level of material is deposited in the center of the substrate, with gradually and progressively less being deposited toward the perimeter of the substrate, whereby a dome shape of adhesive material is deposited on the substrate.

5. The method according to claim 1 in which the adhesive material is applied to the substrate in a dome shape by depositing the adhesive material on the substrate by spin coating in which the adhesive material is spun out over the substrate using centripetal force and the spinning decelerates over time, thereby depositing more material in the center of the substrate and gradually and progressively less toward the perimeter of the substrate, whereby a dome shape of adhesive material is created.
